(19) United States
(12) Patent Application Publication
(10) Pub. No.: US 2016/0241557 A1
(43) Pub. Date: Aug. 18, 2016

(54) METHOD FOR SECURED COMMUNICATION BETWEEN AN OPERATING SYSTEM OF A TERMINAL AND A DEVICE DISTINCT FROM THE TERMINAL

(71) Applicant: OBERTHUR TECHNOLOGIES, Colombes (FR)

(72) Inventors: Yann Philippot, Colombes (FR); Raphael Levenes, Colombes (FR)

(21) Appl. No.: 14/645,061

(22) Filed: Mar. 11, 2015

(30) Foreign Application Priority Data
Feb. 12, 2015 (FR) 1551144

(51) Int. Cl. H04L 29/06

(52) U.S. Cl. CPC H04L 63/0869; H04L 63/0876

(57) ABSTRACT

Disclosed are methods, systems, and devices for secure communication between an operating system of a terminal and a device distinct from the terminal, the terminal further including a reliable execution environment. In various implementations, authentication of said device by said reliable execution environment initiated by said operating system may occur prior to the secure communication. Some embodiments include a terminal and a system comprising the terminal.

### BACKGROUND OF THE INVENTION

The invention relates to the general field of secured communications and in particular between a terminal and a device distinct from the terminal.

A terminal is generally equipped with a non-secured operating system, a so-called “Rich OS”, within which applications are executed. Devices distinct from a terminal may enter into communication with this terminal. Distinct is understood to mean any type of device separated from the terminal, and notably devices which may be connected to the terminal in a reversible way.

As an indication, these devices may be secure elements having the form of a micro SD (“Micro Secure Digital Card”) card, of a microcircuit card with contact or contact-less modes of communication, or an electronic passport. Also and by way of example, a terminal may be a portable telephone or a tablet.

An application using a communication between a terminal and a device is verification of identity. In these applications, keys or certificates stored within the devices may be used.

Data communication between a non-secured operating system, a so-called “rich OS”, and a distinct device is presently not sufficiently secured.

The invention notably aims at overcoming this drawback.

### OBJECT AND SUMMARY OF THE INVENTION

The present invention meets this need by proposing a secure communication method between an operating system of a terminal and a device distinct from the terminal, the terminal further including a reliable execution environment, the method includes, prior to the secure communication, authentication of said device by said reliable execution environment initiated by said operating system.

Thus, it is by using the reliable execution environment which has authentication functions that the communication between the terminal and the device is secured in a simple way.

A reliable execution environment is a secured portion of a terminal, which may be implemented by the main processor of a terminal in a distinct way from the non-secured operating system. This reliable execution environment allows storage of secret and secured data such as keys or certificates. The Global Platform standard describes execution environments such as reliable execution environments. By way of example, a reliable execution environment may at least apply cryptographic functions as defined by the Global Platform standard.

In a specific embodiment, the method includes a mutual authentication of the device and of the reliable execution environment, comprising said authentication of said device by said reliable execution environment and an authentication of the reliable execution environment by said device.

Mutual authentication is an authentication in which the reliable execution environment authenticates the device and the device authenticates the reliable execution environment.

It may be noted that for applying the mutual authentication, the device may apply at least these cryptographic functions according to the Global Platform standard. This may be achieved by means of an application (“applet”) loaded on a JAVA platform.

In a specific embodiment, this mutual authentication includes an exchange through said operating system of cryptograms between said device and said reliable execution environment, the authentication being obtained on the basis of a verification by said device and of a verification by said reliable execution environment, in which the device and the reliable execution environment check that both cryptograms are identical.

In this particular embodiment, a secret is generated in the device and the secured environment. The latter each generate a cryptogram computed from data and from the common secret. These cryptograms are exchanged between the device and the secured reliable environment and checked. This allows mutual authentication to be obtained in a simple way.

In a specific embodiment, the elaboration of each of the cryptograms is applied on the basis of a datum provided by said reliable execution environment, of a datum provided by said device, and of a ciphering key elaborated both by said device and by said reliable execution environment.

These data may be random data elaborated during the initialization of the method. The device itself elaborates this random datum, and the reliable execution environment also itself elaborates this random datum, these data are exchanged before elaborating the cryptograms.

It may be noted that by using cryptograms, it is possible to check that the same ciphering key was used and therefore infer therefrom mutual authentication of the device and of the reliable execution environment.

In a specific embodiment, said ciphering key is elaborated by said device on the basis of a derived key specific to said device, and said ciphering key is elaborated by said reliable execution environment on the base of a key derived and obtained from a master key and from additional data of said device.

In this particular embodiment, the derived key may be a KENC key obtained from a master key and stored in the device and the ciphering key may be an S-ENC key which is a session key, in other words it is elaborated at each application of the method. For this purpose, it is possible to use the data provided by the device and by said reliable execution environment respectively for elaborating the ciphering key. The KENC and S-ENC keys are defined by the Global Platform standard.

Within the reliable execution environment, a master key stored beforehand in this reliable execution environment is derived. This derivation is applied from additional data provided by the device, these data may be diversification data DIV defined by the Global Platform standard and which notably comprise series numbers, batch numbers, manufacturing data, application identifiers. The obtained derived key is the KENC key, and the elaboration of the ciphering key may then be ensured in a similar way to the elaboration of this key within the device.

In a specific embodiment, said secured communication uses at least said ciphering key.

It may be noted that this ciphering key is elaborated every time when the operating system which is to apply a secured communication.

In a specific embodiment, said secured communication further includes a communication of a code for authenticating said data communication, the elaboration of the code using a code elaboration key obtained beforehand within said device and said reliable execution environment.

This code may be a code known to one skilled in the art under the acronym of MAC (“Message Authentication Code”). With this code it is notably possible to guarantee the integrity of the exchanges.

In a specific embodiment, said secured communication includes communication of personal data of a user.

Notably, said personal data are obtained by means of a reliable user interface executed by said reliable execution environment.

A reliable execution environment takes on board a reliable user interface notably allowing the input of codes of the personal identification number type or further the recovery of biometric data in a secured way.

In a specific embodiment, said authentication or mutual authentication is applied upon request from an application executed by said operating system.

Notably, said application communicates with said reliable execution environment by means of a transport layer.

The transport layer defines a communication layer between the non-secured operating system (or an application operating on this operating system) and a reliable execution environment i.e. with a secure element which is in the terminal. This layer is notably defined by the OMAPI (Open Mobile API) standard.

In a specific embodiment, the device is a secure element.

The invention also proposes a terminal taking on board an operating system and a reliable execution environment, the reliable execution environment includes a module for authenticating a device distinct from the terminal upon request from the operating system.

The invention also proposes a system comprising this terminal and a device distinct from the terminal, in which the device includes a module for authenticating the reliable execution environment of the terminal upon request from the operating system.

The terminal and the device of this system may include modules for applying all the particular embodiments of the method as defined herein before.

The invention also proposes a computer program comprising instructions for executing the steps of a secured communication method between a terminal and a device distinct from the terminal, as described above, when said program is executed by a processor of the terminal.

The invention also proposes a recording medium legible by a processor, on which is recorded a computer program, comprising instructions for executing the steps of a secured communication method between a terminal and a device distinct from the terminal as described above.

### SHORT DESCRIPTION OF THE DRAWINGS

Other features and advantages of the present invention will become apparent from the description made below, with reference to the appended drawings which illustrate an example thereof without any limitation.

In the figures:

FIG. 1 schematically illustrates a system comprising a terminal and a device according to an embodiment of the invention,

FIG. 2 schematically illustrates steps of a method according to an embodiment of the invention,

FIG. 3 illustrates in more detail the steps of a method according to an embodiment of the invention.

### DETAILED DESCRIPTION OF AN EMBODIMENT

A system and a secured communication method will now be described, in which mutual authentication of a device and of a reliable execution environment is applied.

It may be noted that it is not mandatory to apply mutual authentication, and that it is possible to obtain authentication by using a reliable execution environment authenticating a device distinct from the terminal equipped with the reliable execution environment.

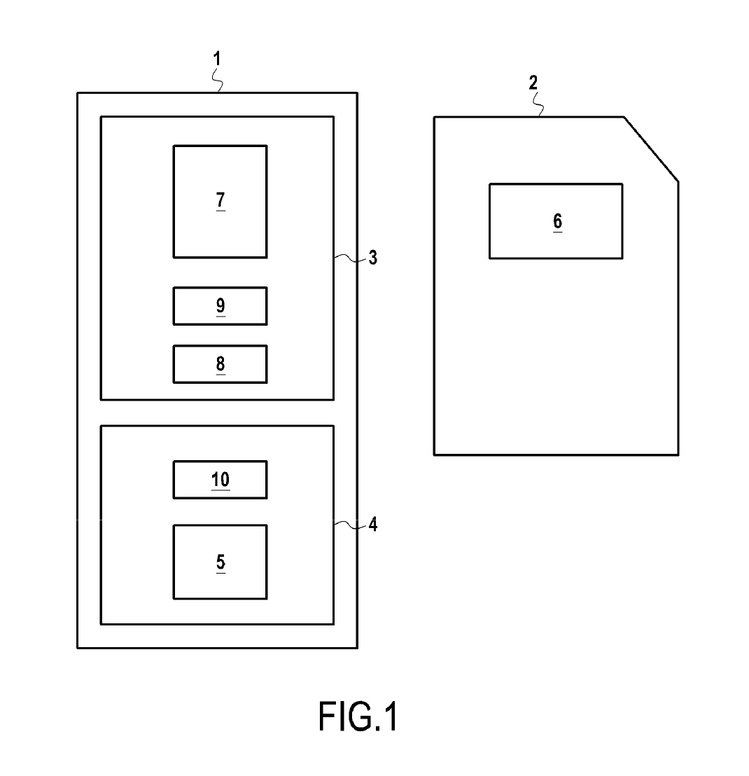

In FIG. 1, a system is illustrated including a terminal 1, for example a telephone or a tablet, and a device 2, for example a secure element such as a micro SD card or a card with a microcircuit.

The terminal 1 and the device 2 may interact when the device 2 is connected in the terminal 1, or further by approaching the device 2 to the telephone if it is possible to use a near field communication protocol.

The invention aims at securing the communications between the device 2 and the terminal 1, in particular when personal information of a user passes between both elements. Indeed, it is possible to use a device distinct from the terminal for applying authentication of a user, the device including certificates and keys which may be used for these purposes.

The terminal 1 takes on board an operating system 3, for example a non-secured operating system of the Android type, and also a reliable execution environment 4.

When the operating system requires the application of a secured communication with the device 2, the operating system 3 requires the use both of the device 2 and of the reliable execution environment 4.

The reliable execution environment 4 includes for this purpose an authentication module 5 for authenticating said device upon request from the operating system 3, and the device includes an authentication module 6 for authenticating said reliable execution environment 4, a device on request from the operating system 3.

In the example illustrated in FIG. 1, this is an application 7 executed by the operating system 3 which initiates the application of mutual authentication. As an indication, this application may be a browser of the “Firefox” type, and it may require authentication for applying an electronic or secured signature, a connection with an online server.

In the solution according to the prior art, the communications between the device 2 and the application 7 are not secured, and it is possible to recover personal data by changing the user interface of the application 7 or further by using a key logger.

In order to apply communications between the application 7 of the operating system 3 and the reliable execution environment 4, a layer 8 according to the OMAPI standard is used. The layer 8 also allows application of communications between the application 7 and the device 2.

Although this is not mandatory, it is possible to use a middleware layer 9 between the application 7 and the transport layer.

Finally, the reliable execution environment includes here a reliable user interface 10, which may allow recovery of the personal data inputted by a user (personal identification number, biometric data . . . ).

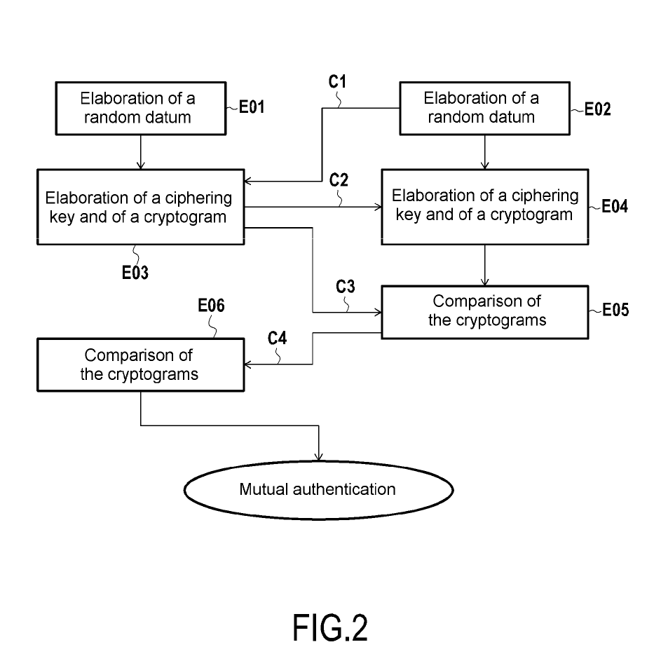

In FIG. 2, different steps of a method have been schematically illustrated according to an embodiment of the invention. The example of FIG. 2 may be implemented by the system described with reference to FIG. 1.

Moreover, in FIG. 2, the steps illustrated on the left of the figure are applied within the device, and the steps illustrated on the right in the figure are applied within the reliable execution environment.

In a first step E01, a random datum is elaborated by the device. It may be noted that the generation of random data is part of the cryptographic functions provided by the Global Platform Standard and which are implemented in secure elements. The step E01 is applied after an initial request from the operating system and from one of its applications. This random datum may have a size of the order of 8 bytes.

In the same way, a random datum is elaborated by the reliable execution environment in a step E02. This random datum may also have a size of the order of 8 bytes.

The datum elaborated during step E02 is transmitted to the device (arrow C1), so that the latter applies a step E03 for elaborating a ciphering key and for elaborating a cryptogram.

The elaboration of the ciphering key may be applied by the device on the basis of a derived key specific to the device of the KENC type, i.e. a key having been derived from a master key on the data base of derivations.

In order to obtain a ciphering key (i.e. a session key for the encryption), it is possible to use the random data of the device and of the reliable execution environment for generating session key derivation data by concatenating these random data. It is then possible to use the KENC key and these session key derivation data for generating an SENC key (the ciphering key) by following the well-known method to one skilled in the art under the acronym of AES (“Advanced Encryption Standard”) using a constant having the value 0182. The S-ENC key may have a size of 16 bytes or further of 32 bytes.

It may be noted that another key may be obtained in a similar way during step E03, in particular a key for elaborating authentication codes of messages (S-MAC key). For this purpose, a KMAC derived key and a constant having the value 0101 are used.

The elaboration of the cryptogram is applied by concatenating the random data of the device and of the reliable execution environment, and then by using the ciphering key noted as S-ENC on the concatenated data.

In a quasi-similar way, during a step E04, the reliable execution environment elaborates a ciphering key and a cryptogram.

Here, the elaboration of the ciphering key further includes the elaboration of the KENC derived key. Also, the KMAC derived key is elaborated.

In order to elaborate the ciphering key and a cryptogram, the random datum of the device, and additional data of the type of diversification data are transmitted to the reliable execution environment (arrow C2).

Next, in a step E05, the reliable execution environment compares the cryptogram which it has elaborated with the cryptogram elaborated by the device which has been transmitted to this reliable execution environment (arrow C3).

In the same way, the device may compare the cryptogram of the reliable execution environment which has been transmitted to it (arrow C4) with the cryptogram which it has elaborated (step E06).

If both comparisons indicate that the cryptograms are identical, mutual authentication is then obtained and it is possible to apply a secured communication using the keys elaborated in steps E03 and E04.

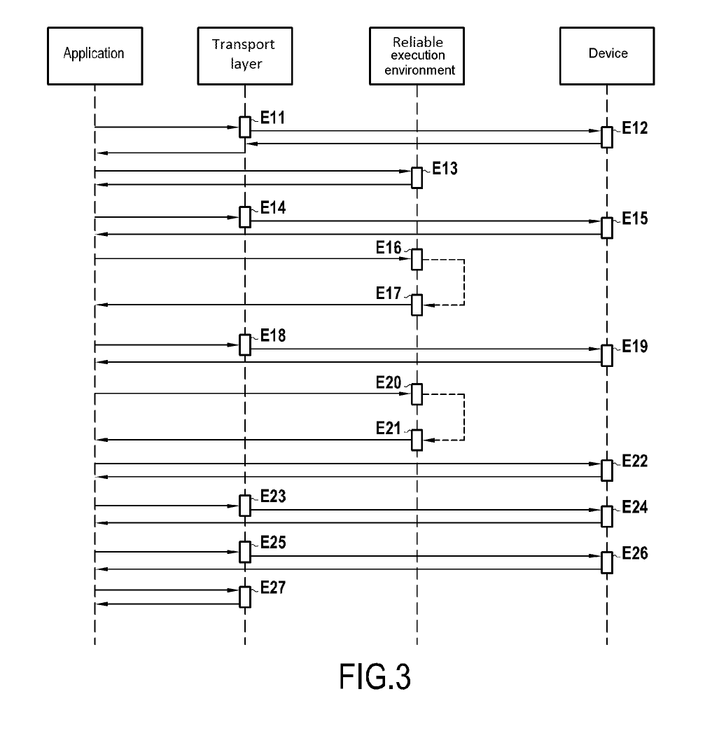

In FIG. 3, various steps of the method of FIG. 2 are illustrated in more detail. In the same way, this method may be applied by the system described with reference to FIG. 1.

In this figure, the elements or layers within which the steps are applied are illustrated by four columns. From left to right, are illustrated:
the application executed by the non-secured operating system,
the layer according to the OMAPI standard,
the reliable execution environment, and
the device.

The succession of the steps is illustrated in this figure with successive arrows in an order from top to bottom on the figure.

The application first transmits a request for opening a secured communication, by opening an OMAPI session, and the layer OMAPI opens a session (step E11) for communicating with the device which receives the request (step E12). Confirmation of this opening is sent to the OMAPI layer and then to the application. It is thus possible to communicate with the device.

It may be noted that in the following, the messages exchanged by the OMAPI, the reliable execution environment, and the device, are messages of the APDU (“Application Protocol Data Unit”) type according to the ISO 7816 standard.

Next, a random datum is elaborated (step E13) by the reliable execution environment, this step is similar to step E02 described with reference to FIG. 2.

The OMAPI layer then transmits a request including the random datum elaborated in step E13 towards the device, in a step E14. In a step E15, a random datum, a ciphering key and a cryptogram are elaborated; this step is similar to steps E01 and E03 of FIG. 2.

The random datum and the cryptogram are re-transmitted to the application which provides them to the reliable execution environment. In a step E16, the reliable execution environment elaborates a ciphering key (by using the random datum of the device), and a cryptogram. Step E16 is similar to step E04 of FIG. 2.

The following step E17 is applied by the reliable execution environment and it includes the comparison of both cryptograms by the reliable execution environment.

A message comprising the cryptogram elaborated by the reliable execution environment is then transmitted if the result of the comparison indicates that the cryptograms are identical.

This message is re-transmitted to the device through the OMAPI layer (step E18), and in a step E19 the device compares the received cryptogram with the cryptogram which it has elaborated.

If the result indicates that the cryptograms are identical then a secured communication may be applied.

This is indicated to the reliable execution environment which, by using its reliable user interface, recovers personal data of the user (for example a personal identification number or biometric data) in a step E20.

These personal data are then encrypted by means of the ciphering key elaborated during step E16, in a step E21. This encryption may be applied by using the ciphering key and the AES method.

Further, it is possible to elaborate a code for authenticating the transmission of the personal data of a MAC message type, by using an elaborated key (of the SMAC type) also during step E16.

The message elaborated in step E21 may be transmitted to the device, which includes the ciphering key as well as the key for elaborating encoded messages.

In a step E22, the device checks the integrity of the received message, and may compare the personal data with personal data stored in memory in the device.

If the result of step E22 is positive, the user is authenticated.

After this step, it is possible to end the secured communication between the application and the device. A request for stopping the secured session may be elaborated in a step E23, and the device may receive this request in a step E24.

The user having been authenticated, it is possible to apply other functions using the device. Notably, after authentication, the user may use the keys contained in the device.

This step is given as an example. In this case, the application sends to the board a field of data in clear text. The board produces a signature on the received data.

Finally, in a step E27, the application may request to the OMAPI layer the end of the OMAPI session.

In the example, the communication used is a communication by contact but it is also possible to envision using a contactless communication such as NFC (“Near Field Communication”), Bluetooth.

1. A secured communication method between an operating system of a terminal and a device distinct from the terminal, the terminal further including a reliable execution environment, the method comprising:
authenticating, prior to the secured communication, said device by said reliable execution environment initiated by said operating system.

2. The method according to claim 1, further comprising:
performing a mutual authentication of the device and of the reliable execution environment, the mutual authentication comprising:
the authenticating of said device by said reliable execution environment and
authenticating of the reliable execution environment by said device.

3. The method according to claim 2, wherein said mutual authentication includes an exchange through said operating system of cryptograms between said device and said reliable execution environment, the authentication being obtained on the basis of a verification by said device and of a verification by said reliable execution environment in which the device and the reliable execution environment check that both cryptograms are identical.

4. The method according to claim 3, wherein an elaboration of each of the cryptograms is carried out on the basis of a datum provided by said reliable execution environment, of a datum provided by said device, and of a ciphering key both elaborated by said device and by said reliable execution environment.

5. The method according to claim 4, wherein said ciphering key is elaborated by said device on the basis of a derived key specific to said device, and said ciphering key is elaborated by said reliable execution environment on the basis of a derived key obtained from a master key and from additional data of said device.

6. The method according to claim 4, wherein said secured communication uses at least said ciphering key.

7. The method according to claim 1, wherein said secured communication further includes communication of a code for authenticating said secured communication, and an elaboration of the code using a code elaboration key obtained beforehand within said device and said reliable execution environment.

8. The method according to claim 1, wherein said secured communication includes communication of personal data of a user.

9. The method according to claim 8, wherein said personal data are obtained by means of a reliable user interface executed by said reliable execution environment.

10. The method according to claim 1, wherein said authenticating is applied upon request from an application executed by said operating system.

11. The method according to claim 10, wherein said application communicates with said reliable execution environment by means of a transport layer.

12. The method according to claim 1, wherein the device is a secure element.

13. A terminal comprising:
an operating system; and
a reliable execution environment that includes a module for authentication of a device distinct from the terminal upon request from the operating system.

14. A system comprising:
a terminal comprising:
an operating system, and
a reliable execution environment that includes a module for authentication of a device distinct from the terminal upon request from the operating system; and
a device distinct from the terminal, wherein the device includes a module for authenticating the reliable execution environment upon request from the operating system.

15. A computer program comprising instructions for executing the steps of a secured communication method between a terminal and a device distinct from the terminal according to claim 1, when said program is executed on a processor of the terminal.

16. A non-transitory recording medium readable by a processor, on which is recorded a computer program comprising instructions for executing the steps of a secured communication method between a terminal and a device distinct from the terminal according to claim 1.
